(19) United States
(12) Patent Application Publication
(10) Pub. No.: US 2010/0314413 A1
(43) Pub. Date: Dec. 16, 2010

(54) Soap Dispenser Assembly with Flexible Conduit

(76) Inventors: Chad H. Jones, Frisco, TX (US); Michael Miller, Colleyville, TX (US)

Correspondence Address: Monty L. Ross;LOCKE LORD BISSELL & LIDDELL LLP, Suite 2200, 2200 Ross Avenue, Dallas, TX, 75201-6776, US

(21) Appl. No.: 12/767,475

(22) Filed: Apr. 26, 2010

Related U.S. Application Data
(60) Provisional application No. 61/186,446, filed on Jun. 12, 2009.

(51) Int. Cl. B05B 11/00

(52) U.S. Cl. 222/173

(57) ABSTRACT

A soap dispenser assembly having a manually operated pump with a suction and a discharge, a dispensing spout, and a flexible conduit providing fluid communication between the assembly and a container or reservoir for liquid soap that is not supported by the dispenser and is instead supported by a substrate disposed below the countertop, sink or lavatory. A check valve is optionally provided.

### CROSS-REFERENCE TO RELATED APPLICATIONS

This application claims the benefit under 37 U.S.C. §119(e) of U.S. Provisional Application No. 61/186,446, filed on Jun. 12, 2009, entitled “SOAP DISPENSER ASSEMBLY WITH FLEXIBLE CONDUIT.”

### TECHNICAL FIELD OF THE INVENTION

The present invention relates to a manually operated soap dispenser assembly that is mountable on a countertop, sink or lavatory and that pumps liquid soap upwardly through a flexible conduit from a container that is not supported by the dispenser and is instead supported by a substrate disposed below the countertop or lavatory.

### SUMMARY OF THE INVENTION

A soap dispenser assembly is provided that is desirably mounted on and supported by a countertop, sink or lavatory. The soap dispenser assembly comprises a manually operated pump, a dispensing spout, and a flexible conduit providing fluid communication between the assembly and a container or reservoir for liquid soap that is not supported by the dispenser and is instead supported by a substrate disposed below the countertop, sink or lavatory. The soap from container is pumped through the conduit to the soap dispenser and discharged from the spout. The container or reservoir desirably contains sufficient liquid soap to accommodate high-volume or long-term use. The container is desirably a plastic bottle or jug that is supported on a floor, base or shelf, preferably disposed inside a cabinet, but the container can also be attachable to and supported by a substantially vertical wall using a mounting bracket or other conventional attachment device suitable for that purpose if desired.

The flexible conduit of the soap dispenser assembly of the invention can optionally comprise a check valve if needed. A check valve can assist in pumping liquid soap a greater distance than is otherwise readily achievable without the use of such a valve depending upon such factors as, for example, the pump suction and outlet pressures, the vertical and horizontal distances between the dispensing spout, pump and container; the diameter of the flexible conduit; and the density and viscosity of the liquid soap.

### BRIEF DESCRIPTION OF THE DRAWINGS

The invention is further described and explained in relation to the following drawing in which:

FIG. 1 is simplified side elevation view of one preferred embodiment of the soap dispenser assembly of the invention as mounted in a cabinet that is shown in cross-section to facilitate viewing of the installation.

### DETAILED DESCRIPTION OF THE INVENTION

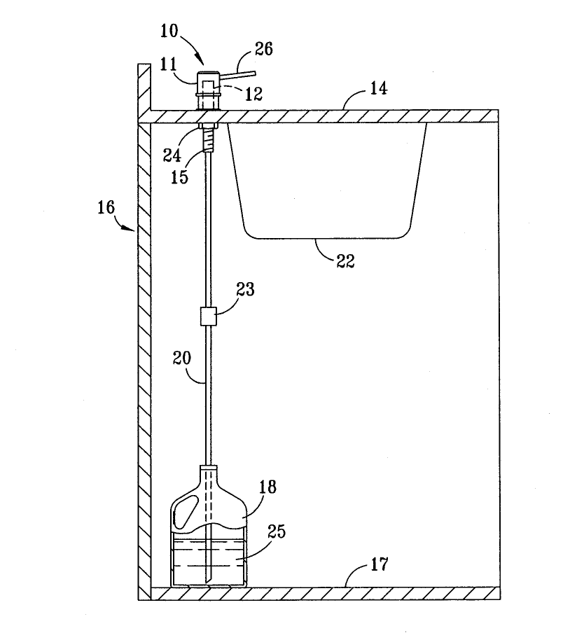

Referring to FIG. 1, soap dispenser assembly 10 preferably comprises a soap dispenser 11, containing a manually operated, piston-actuated, positive displacement pump 12 having a suction and a discharge, and a forwardly projecting soap dispensing spout 26. Suitable manually operated piston-actuated, positive displacement pumps 12 are commercially available. Soap dispenser 11 is preferably made of metal or plastic and is releasably secured by female-threaded locking nut 24 to male-threaded tubular nipple 15 extending through counter surface 14 of a cabinet 16 in which sink 22 is also mounted. Soap dispenser assembly 10 preferably further comprises a flexible conduit 20 that provides fluid communication between the soap dispenser 12 and the interior of a container 18 that contains liquid soap 25 to be pumped upwardly through soap dispenser 12 and discharged through dispensing spout 26.

As illustrated in FIG. 1, container 18 sits on the substrate forming base 17 of cabinet 16, but it will be appreciated that container 18 can also sit on the floor (such as, for example, if cabinet 16 has no base), or be supported by another horizontal substrate (not shown) forming an intermediate shelf, or from a vertical substrate such as the back wall of cabinet 16. The length and diameter of flexible conduit 20, preferably polymeric tubing, are desirably such that pump 12 of soap dispenser 11 will be able to pump soap 25 from container 18 up to and through the free end of soap dispensing spout 26. Check valve 23 is optionally provided in flexible conduit 20 to facilitate upward movement of the soap if the length and diameter of flexible conduit 20 are such that assistance is needed to supplement the suction of pump 12 inside soap dispenser 11.

It should be appreciated by those reading the instant disclosure that soap dispensing spout 26 can have various configurations without departing from the scope of the invention.

Other alterations and modifications of the invention disclosed herein will likewise become apparent to one of ordinary skill in the art upon reading this disclosure with reference to the accompanying drawing, and the inventors intend that the scope of this invention be limited only by the broadest interpretation of the appended claims to which they are legally entitled.

What is claimed is:

1. A soap dispenser assembly, comprising:
a liquid soap dispenser releasably mounted on a mounting surface, the liquid soap dispenser comprising a manually operated pump having a suction and a discharge, and a soap dispensing spout communicating with the discharge; and
a flexible conduit having a first end disposed in fluid communication with the pump suction and a second end disposed in fluid communication with liquid soap inside a container that is supported on or by a substrate disposed below the liquid soap dispenser and pump.

2. The soap dispenser assembly of claim 1 wherein the substrate is a floor.

3. The soap dispenser assembly of claim 1 wherein the substrate is a base.

4. The soap dispenser assembly of claim 1 wherein the substrate is a shelf.

5. The soap dispenser assembly of claim 1 wherein the substrate is a vertical wall.

6. The soap dispenser assembly of claim 1 wherein the flexible conduit is polymeric tubing.

7. The soap dispenser assembly of claim 1 wherein the flexible conduit comprises a check valve.
